(19) United States
(12) Patent Application Publication
(10) Pub. No.: US 2025/0358668 A1
(43) Pub. Date: Nov. 20, 2025

(54) EXTENDED REALITY SERVICE BY ENABLINB RADIO-ACCESS NETWORK AWARENESS

(71) Applicant: Meta Platforms Technologies, LLC, Menlo Park, CA (US)

(72) Inventors: Liwen YU, Santa Clara, CA (US); Zhu JI, Cupertino, CA (US); Curt WONG, Bellevue, WA (US)

(73) Assignee: Meta Platforms Technologies, LLC, Menlo Park, CA (US)

(21) Appl. No.: 19/209,732

(22) Filed: May 15, 2025

Related U.S. Application Data
(60) Provisional application No. 63/648,083, filed on May 15, 2024.

(51) Int. Cl. H04W 28/02

(52) U.S. Cl. CPC H04W 28/0236; H04W 28/0268

(57) ABSTRACT

Systems and methods for extended reality services by enabling radio-access network awareness may include an endpoint which receives, from a wireless communication node, signaling indicating radio-access network (RAN) awareness information including one or more quality of service (QoS) metrics for the wireless communication node. The endpoint may transmit one or more packets to the wireless communication node according to the QoS metrics from the RAN awareness information received from the wireless communication node.

### CROSS-REFERENCE TO RELATED APPLICATIONS

This application claims the benefit of and priority to U.S. Provisional Application No. 63/648,083, filed May 15, 2024, the contents of which are incorporated herein by reference in its entirety.

### FIELD OF DISCLOSURE

The present disclosure is generally related to wireless communication, including but not limited to, systems and methods for radio-access network (RAN) awareness for extended reality services using cellular communication.

### BACKGROUND

Augmented reality (AR), virtual reality (VR), and mixed reality (MR) are becoming more prevalent, with such technology being supported across a wider variety of platforms and device. Some AR/VR/MR devices may communicate with one or more other remote devices via a cellular connection.

### SUMMARY

In one aspect, this disclosure relates to a method including receiving, by a wireless communication endpoint from a wireless communication node, signaling indicating radio-access network (RAN) awareness information including one or more quality of service (QoS) metrics for the wireless communication node. The method may include transmitting, by the wireless communication endpoint, one or more packets to the wireless communication node according to the QoS metrics from the RAN awareness information received from the wireless communication node.

In some embodiments, the method further includes generating, by wireless communication endpoint, the one or more packets using a bitrate determined according to the QoS metrics from the RAN awareness information received from the wireless communication node. In some embodiments, the one or more QoS metrics are for one or more QoS flows used by the wireless communication endpoint. The method may further include determining, by the wireless communication endpoint, the bitrate for generating the one or more packets based on the QoS metrics for each of the one or more QoS flows. In some embodiments, the QoS metrics include a data rate for use by the wireless communication endpoint for transmitting the one or more packets on a QoS flow. In some embodiments, the method further includes generating, by the wireless communication endpoint, the one or more packets according to a bitrate determined based on the data rate indicated in the RAN awareness information.

In some embodiments, the wireless communication endpoint includes at least one of a user equipment or an application server. In some embodiments, the QoS metrics include at least one of i) an indication of a portion of packets dropped during transmission by the wireless communication node, ii) a time delay for a packet to be transmitted by the wireless communication node, or iii) a level of traffic on a wireless network corresponding to the wireless communication node. In some embodiments, the indication and the time delay corresponds to a QoS flow of a plurality of QoS flows. In some embodiments, the signaling includes at least one of a medium access control control element (MAC CE) signaling or a radio resource control (RRC) signaling. In some embodiments, the one or more QoS metrics include a change from one first QoS metrics to one or more second QoS metrics.

In another aspect, this disclosure relates to a wireless communication endpoint including a transceiver and one or more processors configured to receive, via the transceiver from a wireless communication node, signaling indicating radio-access network (RAN) awareness information including one or more quality of service (QoS) metrics for the wireless communication node. The one or more processors may be configured to transmit, via the transceiver to the wireless communication node, one or more packets according to the QoS metrics from the RAN awareness information received from the wireless communication node.

In some embodiments, the one or processors are further configured to generate the one or more packets using a bitrate determined according to the QoS metrics from the RAN awareness information received from the wireless communication node. In some embodiments, the one or more QoS metrics are for one or more QoS flows used by the wireless communication endpoint. The one or more processors may be configured to determine the bitrate for generating the one or more packets based on the QoS metrics for each of the one or more QoS flows. In some embodiments, QoS metrics include a data rate for use by the wireless communication endpoint for transmitting the one or more packets on a QoS flow. In some embodiments, the one or more processors are further configured to generate the one or more packets according to a bitrate determined based on the data rate indicated in the RAN awareness information.

In some embodiments, the wireless communication endpoint includes at least one of a user equipment or an application server. In some embodiments, the QoS metrics include at least one of i) an indication of a portion of packets dropped during transmission by the wireless communication node, ii) a time delay for a packet to be transmitted by the wireless communication node, or iii) a level of traffic on a wireless network corresponding to the wireless communication node. In some embodiments, the indication and the time delay corresponds to a QoS flow of a plurality of QoS flows. In some embodiments, the signaling includes at least one of a medium access control control element (MAC CE) signaling or a radio resource control (RRC) signaling.

In yet another aspect, this disclosure relates to a non-transitory computer readable medium storing instructions that, when executed by one or more processors, cause the one or more processors to receive, via a receiver from a wireless communication node, signaling indicating radio-access network (RAN) awareness information including one or more quality of service (QoS) metrics for the wireless communication node. The instructions may further cause the one or more processors to transmit, via a transmitter, one or more packets to the wireless communication node according to the QoS metrics from the RAN awareness information received from the wireless communication node.

device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5A is a block diagram of a system for radio-access network (RAN) awareness for extended reality services using cellular communication, according to an example implementation of the present disclosure.

FIG. 5B is a network diagram of the system shown in FIG. 5A, according to an example implementation of the present disclosure.

FIG. 6 is a process flow for RAN awareness for extended reality services using cellular communication, according to an example implementation of the present disclosure.

FIG. 7 is another process flow for RAN awareness for extended reality services using cellular communication, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

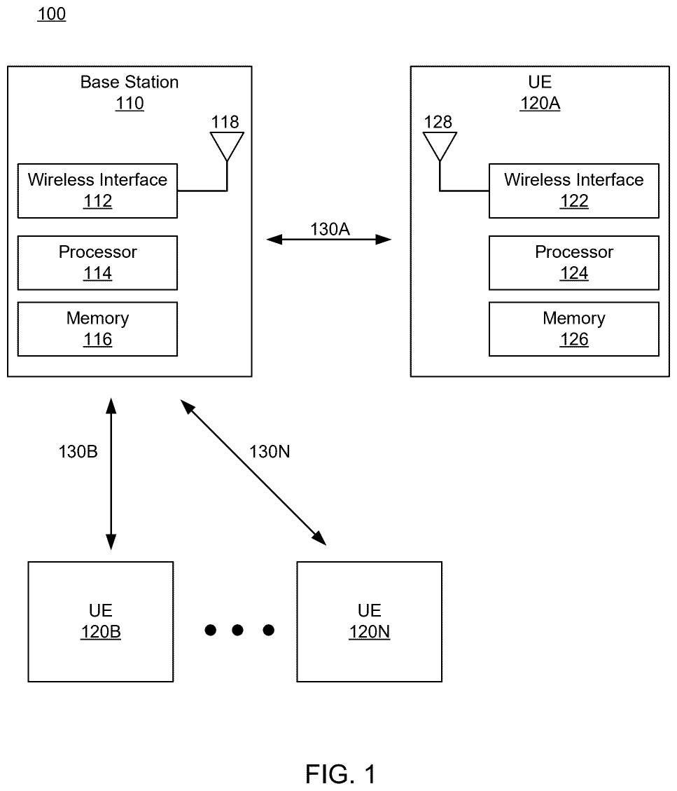

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and can provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

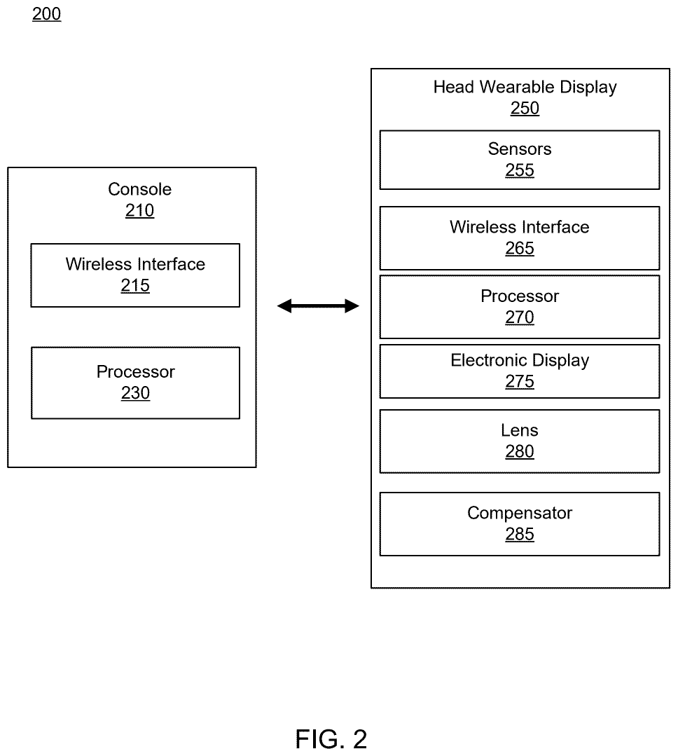

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and can determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and can capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and can append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

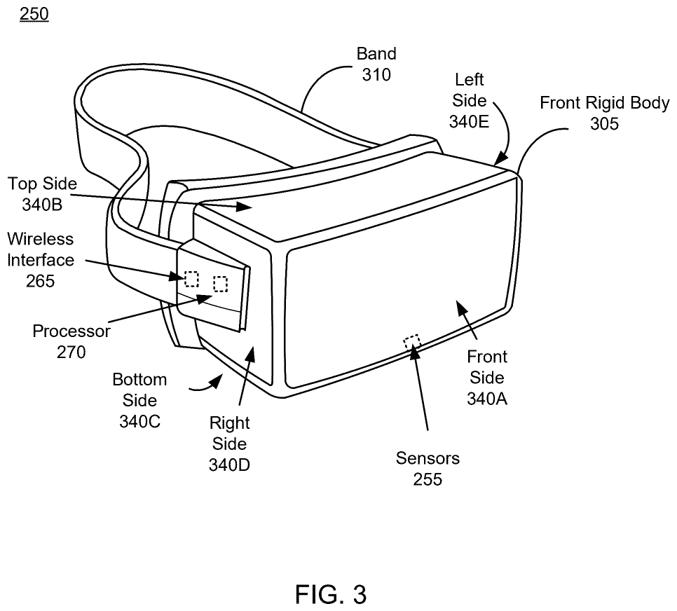

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

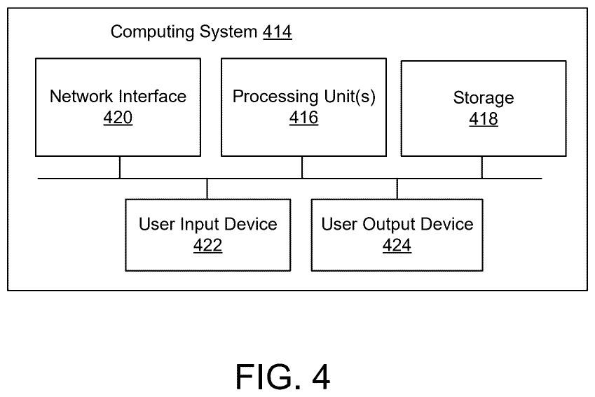

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

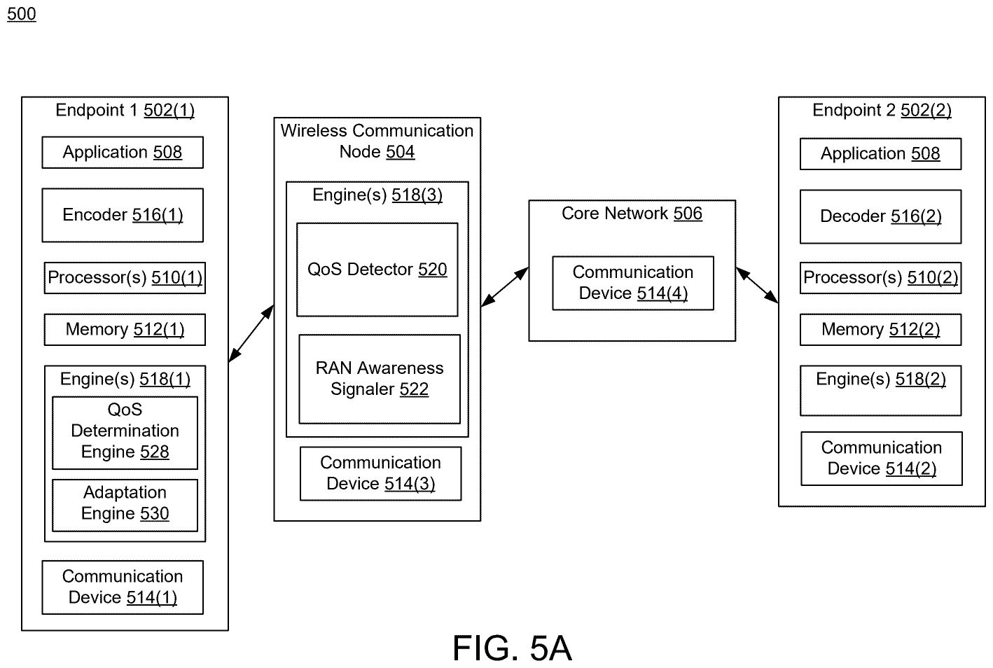

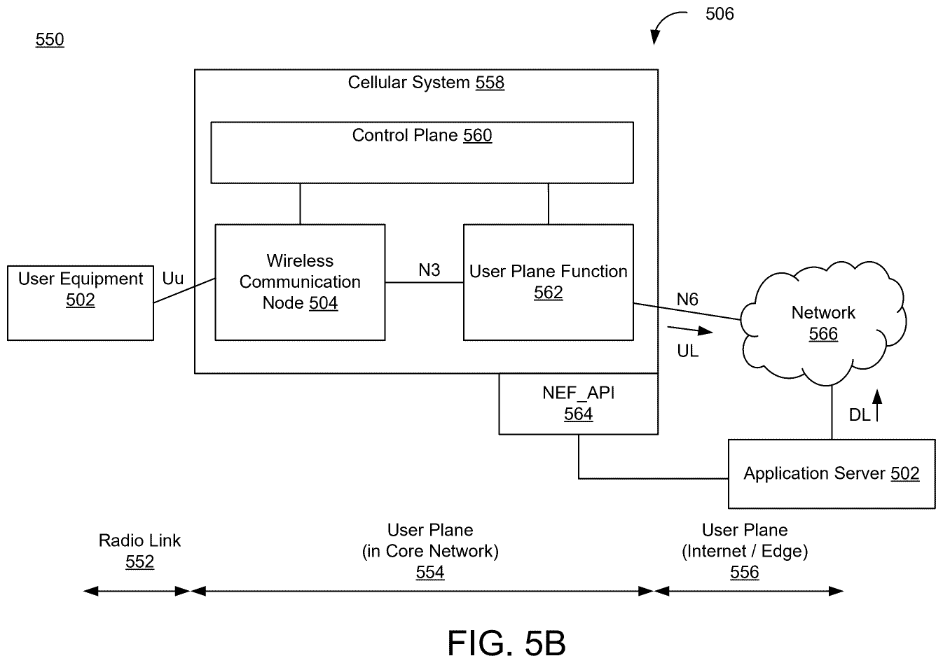

Referring generally to FIG. 5A-FIG. 8, the systems and methods described herein may provide for extended reality systems which leverage or otherwise use radio-access network (RAN) awareness information relating to quality of service (QoS) metrics of a wireless communication node (such as a base station). A user equipment (UE) may benefit from understanding information relating to network congestion of a base station. Some solutions may involve the base station indicating congestion experienced (CE) or explicit congestion notification (ECN) bits in an IP header for packets which are exchanged by the base station to endpoints (e.g., using low latency low loss scalable throughput (LAS) signaling). In such a solution, for instance, a first endpoint may transmit a packet to a second endpoint, which may be marked with a CE bit by an intermediary base station. The second endpoint may indicate that congestion was experienced by the base station back to the first endpoint, based on the CE/ECN bits in the IP header in the packet. In such solutions, there may be increased latency and time delays in the first endpoint determining congestion of the base station, and in the interim, the first endpoint (and second endpoint) may further contribute to additional congestion.

In various embodiments of the systems and methods described herein, an endpoint (such as user equipment or an application server) may be configured to receive signaling from a wireless communication node (such as an endpoint) which indicates radio-access network (RAN) awareness information including one or more quality of service (QoS) metrics for the wireless communication node. The endpoint may be configured to transmit one or more packet(s) to the wireless communication node according to the QoS metrics from the RAN awareness information received from the wireless communication node.

According to the systems and methods of the present solution, by providing the RAN awareness information in signaling (which may be separate from an IP packet header, such as in a medium access control control element (MAC CE) signaling or radio resource control (RRC) signaling), the endpoint may be configured to adapt packet generation and transmission quicker than solutions which involve CE/ECN bits in IP packet headers. Such implementations may ease congestion on wireless networks and the wireless communication node. Additionally, by providing the QoS metrics, which may indicate recommended/suggested QoS parameters to be used by the endpoint (such as a data rate per QoS flow), the endpoints may be configured to adapt codec/data bitrate based on the QoS parameters from the wireless communication node, as opposed to lowering/adapting the bitrate blindly based on an indication of congestion experienced by the wireless communication node. Such solutions may provide for better quality of experience (QoE) in, e.g., extended reality (XR) implementations. Various other improvements and technical advantages over other solutions are described in greater detail below.

Referring to FIG. 5A and FIG. 5B, depicted is a block diagram of a system 500 for radio-access network (RAN) awareness for extended reality services using cellular communication, and a network diagram 550 of the system 500, respectively, according to an example implementation of the present disclosure. The system 500 may include elements, hardware, or components similar to those described above with reference to FIG. 1-FIG. 4. For example, the system 500 may include one or more wireless communication endpoints 502 (generally referred to as endpoints 502, and transmitting endpoint 502(2) and receiving endpoint 502(1), respectively), a wireless communication node 504, and core network 506. The endpoints 502 may be similar to the user equipment 120, console 210, and/or head wearable display 250 described above with reference to FIG. 1-FIG. 4, and/or an application server which is hosting one or more resources/services/applications 508 executable by another endpoint 502. In other words, and in various embodiments, the endpoints 502 may be or include an application server and/or user equipment (e.g., in a peer-to-peer communication session and/or in communication with an application server). The system 500 may include a wireless communication node 504. The wireless communication node 504 may be, include, or be similar to the base station 110 described above with reference to FIG. 1. The system 500 may also include a core network 506, which may support, provide, or otherwise be associated with various wireless communication nodes (e.g., including the wireless communication node 504).

The endpoints 502 may include respective processor(s) 510, memory 512, communication device(s) 514. While processor(s) 510 and memory 512 are shown as included on the endpoints 502, it should be understood that the wireless communication node 504 and/or core network 506 may include similar hardware/components/elements. The processor(s) 510 may be the same as or similar to the processors 114, 124, 230, 270 and/or processing unit(s) 416 described above with reference to FIG. 1-FIG. 4. The memory 512 may be the same as or similar to memory 116, 126, and/or storage 418 described above with reference to FIG. 1-FIG. 4. The communication device 514 may be the same as or similar to the wireless interface 112, 122, 215, 265 (e.g., in combination with or communicably coupled to antenna 118, 128) and/or network interface 420 described above with reference to FIG. 1-FIG. 4.

The endpoints 502 may include respective encoders 516(1) and decoders 516(2). It should be understood that, while the encoder 516(1) is shown as being included on the first endpoint 502(1) and the decoder 516(2) is shown as being included on the second endpoint 502(3), in various embodiments, the second endpoint 502(3) may similarly include an encoder 516(1), and the first endpoint 502(1) may include a decoder 516(2). As such, the first endpoint 502(1) may be a transmitting endpoint, which includes an encoder 516(1) for generating packets for transmission to the second endpoint 502(2) having a decoder 516(2) for decoding such encoded packets. Similarly, the first endpoint 502(1) may be a receiving endpoint, which includes a decoder 516(2) for decoding packets encoded and transmitted by the second endpoint having a corresponding decoder 516(1).

As described in greater detail below, a transmitting endpoint 502 may be configured to encode packet(s) at a first bitrate (e.g., a first FEC ratio, a first video codec rate, and so forth) via the encoder 516, for transmission to the receiving endpoint 502. The transmitting endpoint 502 may be configured to transmit the packet(s) to the wireless communication node 504 for transmission to the receiving endpoint 502. Where the wireless communication node 504 experiences congestion (e.g., prior to, responsive to, or following receipt of the packet(s) from the transmitting endpoint 502), the wireless communication node 504 may be configured to transmit, communicate, or otherwise provide a signaling indicating radio-access network (RAN) awareness information to the transmitting endpoint 502. The RAN awareness information may include quality of service (QoS) metrics for the wireless communication node 504. The transmitting endpoint 502 may be configured to use the QoS metrics included in the RAN awareness information to update the bitrate of the encoder 516 used to generate subsequent packet(s) for transmission to the receiving endpoint 502.

The endpoints 502, wireless communication node 504, and core network 506 may include various processing engine(s) 518. The processing engine(s) 518 may be or include any device, component, element, or hardware designed or configured to perform one or more of the functions described herein. While certain processing engine(s) 518 are shown and described herein, it should be understood that additional and/or alternative processing engine(s) 518 may be implemented on the endpoints 502, wireless communication node 504, and/or core network 506. Additionally, two or more of the processing engine(s) 518 may be implemented as a single processing engine 518. Furthermore, one of the processing engine(s) 518 may implemented as multiple processing engines 518.

Referring specifically to FIG. 5B, the network diagram 550 may include a radio link 552 between an endpoint 502 (e.g., a user equipment endpoint 502) and the wireless communication node 504, a user plane 554 which is internal to the core network 506, and a user plane 556 which is between the core network 506 over a network 566 (which can be the public Internet or a link to an edge device/server) to another endpoint 502 (e.g., an application server endpoint 502). As shown in FIG. 5B, the core network 506 may include a cellular system 558 (e.g., a 5G cellular system 558) including a control plane 560, various wireless communication nodes 504, and a user plane function 562. The cellular system 558 may also include a network experience function (NEF) application programming interface (API) 564 which exposes various network services to external applications and systems, such as the application server endpoint 502. The user equipment endpoint 502 may be configured to communicate with the wireless communication node 504 over a Uu interface. The core network 506 may be configured to communicate with the application server endpoint 502 over an N6 interface. Packets exchanged between the endpoints 502 over the core network 506 may be routed via the user plane function 562 on an N3 interface.

The endpoints 502 may be configured to generate, establish, request, or otherwise maintain one or more connection(s) with each other over the core network 506. For example, a UE endpoint 502 may be configured to maintain on-demand wireless connection(s) with wireless communication node(s) 504 based on location/movement/proximity of the UE endpoint 502 to a respective wireless communication node 504 of the core network 506. In some implementations, an application server endpoint 502 may be configured to maintain a wired/wireless connection with the core network 506 (e.g., via the network 566), which may be persistent/semi-persistent/on-demand.

The endpoint 502 may be configured to request establishing a connection with a wireless communication node 504 (and/or the core network 506) for transmission of/exchange of data with another endpoint 502. For instance, and with respect to a UE endpoint 502, as part of such a request to establish a connection, the UE endpoint 502 may indicate information for requesting one or more quality of service (QoS) flows for use in exchanging such data. The QoS flows may be or include logical channels within the cellular network which carry data with specific QoS characteristics. For example, the QoS characteristics may include minimum service levels, such as (but not limited to), guaranteed bit rate, latency, and reliability. The QoS flows may be requested by the UE endpoint 502 and/or granted by the wireless communication node 504 based on or according to the application/resource/service (generally, application 508) which corresponds to the data which is to be exchanged.

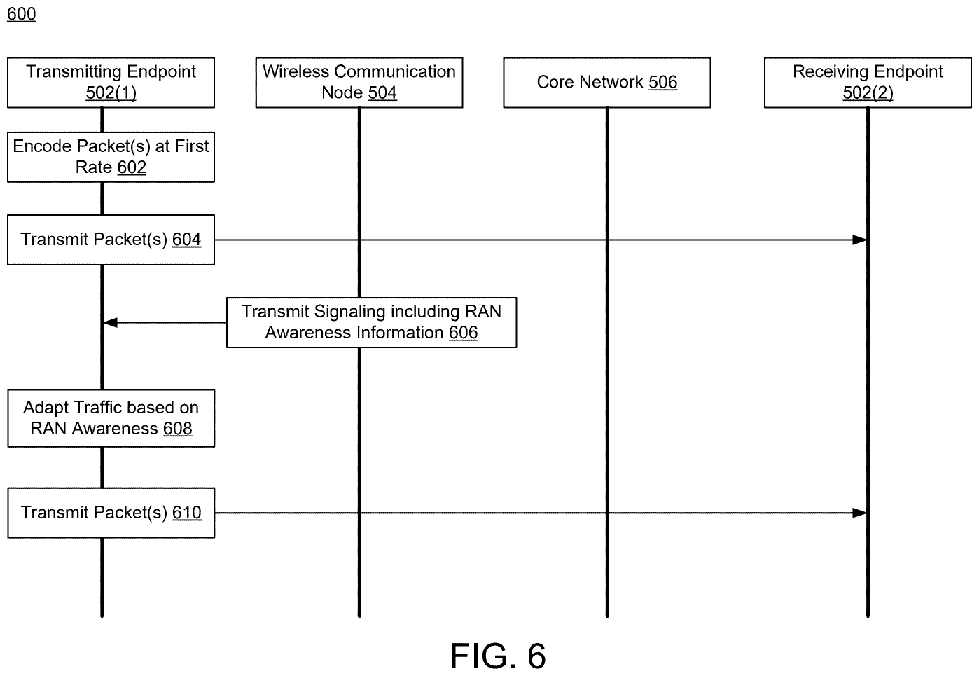

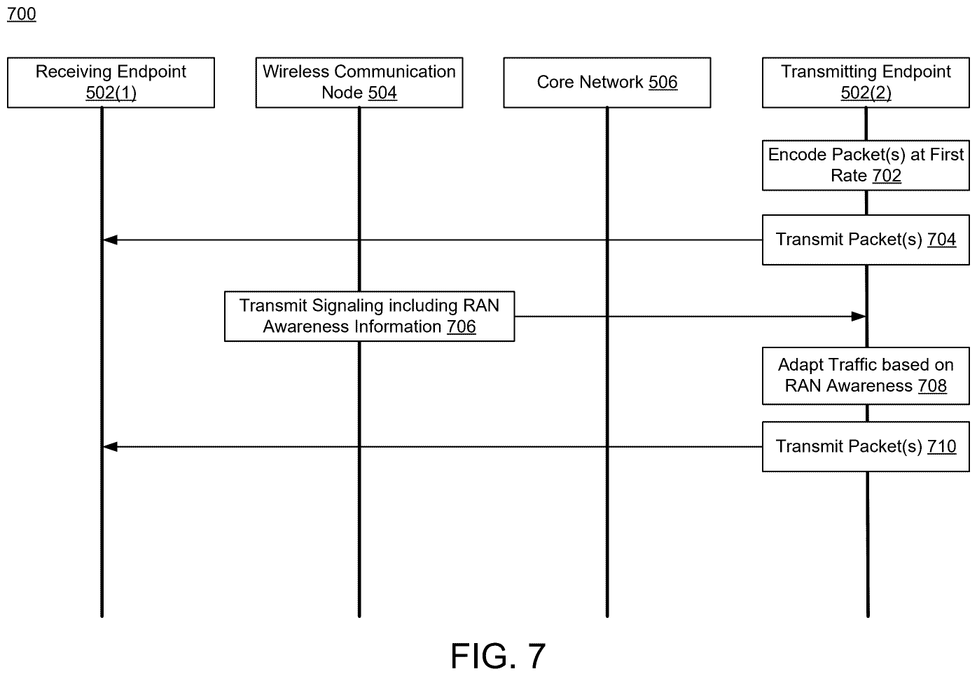

Referring to FIG. 6 and FIG. 7, depicted are process flows 600, 700 for RAN awareness for extended reality services using cellular communication, according to example implementations of the present disclosure. In the example shown in FIG. 6, a user equipment endpoint 502 may use RAN awareness signaling for adapting extended reality services according to QoS metrics from the wireless communication node 504. In the example shown in FIG. 7, an application server endpoint 502 may use RAN awareness signaling for adapting extended reality services according to QoS metrics from the wireless communication node 504. It should be understood that the process flows 600, 700 may be executed or performed in parallel (in that, one process flow may not be dependent from the other process flow). The process flows 600, 700 may be executed by the hardware, components, or elements introduced above in FIG. 5A and FIG. 5B, and described in greater detail below.

Specifically in FIG. 6, and with continued reference to FIG. 5, at process 602, a user equipment (UE) endpoint 502 may be configured to encode one or more first packet(s) according to a first bitrate. Likewise, and specifically in FIG. 7, at process 702, an application server endpoint 502 may be configured to encode one or more first packet § according to a first bitrate. In various embodiments, the endpoint 502 may be configured to generate a first set of packets responsive to execution of the application 508. For example, the application 508 may be or include an extended reality (XR) application, such as but not limited to a voice, video, or avatar-based call/conferencing application, a gaming application, a virtual reality or augmented reality application, etc. The application 508 may include or involve generation of video data (e.g., raw video data), audio data, control data, or any other type/form/format of data for transmission to a receiving endpoint 502 (e.g., UE endpoint 502 or application server endpoint 502) at various time instances, responsive to execution of the application 508. For example, the application 508 may generate video data based on captured video frames from one or more camera(s) of the UE endpoint 502, based on stored and/or rendered video content, etc.

As shown in FIG. 5, the first endpoint 502(1) may include an encoder 516(1). The encoder 516(1) may be or include any device, component, element, or combination of hardware and software designed or configured to generate, configure, establish, derive, or otherwise encode data from one format to another format suitable for transmission over the core network 506. In some embodiments, the encoder 516(1) may include an audio or video encoder, a forward error correction (FEC) encoder, or any other type/form of encoder. Generally speaking, a video encoder may be configured to generate, configure, establish, derive, or otherwise encode the video data into a format for transmission to the receiving endpoint 502(1). For example, the video encoder may be configured to apply compression to the video data (e.g., using a video codec, such as H.264, H.265, AV1, etc.), to generate encoded video packets. An audio encoder may be configured to generate, configure, establish, derive, or otherwise encode the audio data into a format for transmission to the receiving endpoint. For example, the audio encoder may be configured to apply compression to the audio data (e.g., using an audio codec, such as AAC, MP3, Opus, etc.), to generate encoded audio packets. A FEC encoder may be configured to generate, configure, or otherwise provide one or more FEC packets (e.g., redundant packets, FEC parity packets, etc.) using the encoded packets from another encoder (such as an audio or video encoder). In various embodiments, the FEC encoder may be configured to generate the FEC packet(s) by applying/adding redundancy to the encoded packets. For example, the FEC encoder 516 may be configured to encode the video packets from the video encoder, with additional parity or redundant packets, based on an FEC scheme, such as Reed-Solomon or LDPC (Low-Density Parity-Check).

At process 604 and 704, the transmitting endpoint 502(1) may be configured to transmit, communicate, send, or otherwise provide encoded packets to the receiving endpoint 502(2). In process 604, as the transmitting endpoint 502(1) is a UE endpoint 502, the UE endpoint 502 may be configured to provide the encoded packets over the Uu interface to the wireless communication node 504. The wireless communication node 504 may transmit the packet(s) over the N3 interface to the UPF 562. The UPF 562 may be configured to forward the packet(s) over the N6 interface and network 566 to the application server endpoint 502(2) (or forward the packet(s) over the N3 interface to another wireless communication node 504 which transmits the packet(s) to another UE endpoint 502(2)). In process 704, as the transmitting endpoint 502(2) is the application server endpoint 502, the application server endpoint 502 may be configured to transmit the packet(s) via the network 566 over the N6 interface to the UPF 562. The UPF 562 may be configured to forward the packet(s) over the N3 interface to another wireless communication node 504 which transmits the packet(s) to the UE endpoint 502(2).

The transmitting endpoint 502 may be configured to transmit the encoded packet(s) via respective QoS flow(s) of the connection between the transmitting endpoint 502(1) and receiving endpoint 502(2) over the core network 506. For example, where the packet(s) relate to an avatar-based call between the endpoints 502, the transmitting endpoint 502(1) may be configured to transmit the encoded packet(s) corresponding to avatar-based signaling (e.g., control signaling) over a low-latency QoS flow and transmit the encoded packet(s) corresponding to background information over a non-guaranteed bitrate QoS flow.

The wireless communication node 504 may include a QoS detector 520 and a RAN awareness signaler 522. The QoS detector 520 may be configured to detect, identify, compute, or otherwise determine QoS conditions relating to operation of the wireless communication node 504. In various embodiments, the QoS detector 520 determines QoS conditions on a per-flow basis for specific QoS flows and/or across multiple QoS flows in an aggregate or flow-agnostic manner. In some embodiments, the QoS detector 520 may be configured to determine QoS metrics based on or according to the QoS conditions. The QoS metrics may include the QoS conditions themselves and/or information derived from, determined based on, or otherwise identified corresponding to the QoS conditions. The RAN awareness signaler 522 may be configured to communicate, transmit, send, or otherwise provide signaling which includes RAN awareness information including the QoS metric(s) determined by the QoS detector 520.

The QoS detector 520 may be configured to determine various QoS conditions relating to operation or service of the wireless communication node 504. The determined QoS conditions may include, but are not limited to, throughput rates, packet loss, flow delay, and/or flow congestion associated with the wireless communication node 504. The QoS detector 520 may be configured to determine a throughput rate by calculating the amount of successfully transmitted packet data (e.g., in bits per second) within a defined measurement window or time interval. The QoS detector 520 may be configured to determine packet loss by comparing transmitted packet sequence numbers or acknowledged transmissions to detect lost or dropped packets associated with either uplink or downlink directions of the wireless communication node 504. The QoS detector 520 may be configured to determine packet loss as a ratio or percentage of total packets transmitted (e.g., by the transmitting endpoint 502(1)) that are successfully received (e.g., by the receiving endpoint 502(2)). The QoS detector 520 may be configured to determine flow delay based on timestamps recorded at ingress and egress of packets at the wireless communication node 504. For example, the QoS detector 520 may be configured to measure time delay by determining a difference between the time when the wireless communication node 504 receives packets from the transmitting endpoint 502(1), and the time when the wireless communication node 504 transmits or forwards those packets toward the receiving endpoint 502(2). The QoS detector 520 may be configured to determine a flow congestion at the wireless communication node 504, for example, by tracking resource utilization or comparing current total or average throughput against a maximum achievable throughput or node capacity at the radio interface (e.g., Uu interface). As another example, the QoS detector 520 may be configured to determine flow congestion by monitoring buffer occupancy within the wireless communication node 504, identifying when buffering thresholds satisfy (e.g., meet or exceed) predetermined thresholds, and/or determining whether new incoming packets must be dropped or queued due to limited buffer space availability.

In some embodiments, the QoS detector 520 may be configured to determine QoS conditions at various time intervals. For example, the QoS detector 520 may be configured to determine the QoS conditions periodically (e.g., every N milliseconds or seconds), on-demand (e.g., responsive to a change in a level of network traffic or congestion which satisfies a threshold criterion), and/or continuously (e.g., in real time or substantially real-time).

The QoS detector 520 may be configured to determine QoS metrics based on or according to the QoS conditions of the wireless communication node. The QoS metrics may be or include some (or all) of the QoS conditions, and/or information determined/derived from the QoS conditions. In various implementations, the QoS metrics include or directly incorporate measured QoS conditions for specific QoS flows, combined groups of flows, and/or provide aggregated data reflective of the node-level operation (e.g., overall system-level throughput, congestion indicators, average node latency, and so forth).

In some embodiments, the QoS detector may be configured to determine the QoS metrics by deriving one or more of the QoS metrics from one or more of the QoS conditions of the wireless communication node 504. For example, the QoS detector 520 may be configured to determine a QoS metric corresponding to a data rate. The data rate may be or include a target/suggested/maximum/available/recommended data rate which is to be used for communication with the wireless communication node 504. In some embodiments, the data rate may be per QoS flow, per group(s) of QoS flows, and/or per node. The QoS detector 520 may be configured to determine the data rate based on or according to one or more of the QoS conditions such as, for example, throughput rate, packet-loss values, and/or flow congestion. The QoS detector 520 may be configured to adjust, modify, adapt, change, or otherwise configure the available or recommended data rate (e.g., upward or downward) dynamically, according to ongoing or updated measurements of QoS conditions to accommodate changing network circumstances.

In some embodiments, the data rate from the QoS metrics may be or include an available or recommended data rate. The available/recommended data rate may be an absolute value which the endpoint is suggested to use for a QoS flow. In some embodiments, the data rate may be or include a maximum available data rate. The maximum available data rate may be an upper limit for a data rate, below which the endpoint 502 can use any data rate for the QoS flow. In some embodiments, the data rate may be a relative data rate (e.g., a change or delta from a previous available/recommended data rate or a maximum available data rate). In this regard, the QoS metrics may include a change from a previous QoS metric (e.g., a change/delta from the previous QoS metric). While described with reference to the data rate, it should be understood that the relative/change in QoS metrics may be applied to other potential QoS metrics, such as packet loss, time delay, and so forth.

At process 606 and process 706, the RAN awareness signaler 522 may be configured to generate and transmit, communicate, send, or otherwise provide signaling of RAN awareness information which includes the QoS metrics (e.g., determined by the QoS detector 520). The RAN awareness signaler 522 may be configured to provide the signaling to the transmitting endpoint 502(1) as over-the-air signaling (e.g., radio signaling). For example, the signaling may be or include a medium access control (MAC) control element (CE) signaling and/or a radio resource control (RRC) signaling. The signaling may be or include a MAC CE or RRC signaling which is separate from the packet(s) transmitted by or received by the endpoint 502(1). While shown as being performed after processes 604 and 704, respectively, it should be understood that the RAN awareness signaler 522 may be configured to transmit, communicate, send, or otherwise provide the signaling at any point in time during the connection with the transmitting endpoint 502 (e.g., prior to and/or following the endpoint 502 transmitting the packet(s) at process 604 and 704).

In some embodiments, the RAN awareness signaler 522 may be configured to transmit the signaling including the RAN awareness information responsive to detecting a change in the QoS metrics. For example, the RAN awareness signaler 522 may be configured to generate and transmit RAN awareness signaling responsive to determining QoS congestion conditions at the wireless communication node 504 satisfying (e.g., being greater than, or greater than or equal to) a predetermined packet-loss threshold value (such as packet loss rate satisfying a 2% threshold value), observing throughput capacity satisfying predetermined utilization thresholds, and/or a change (e.g., increase or decrease) in delay metrics satisfying a threshold delay. Additionally or alternatively, the RAN awareness signaler 522 may be configured to transmit RAN awareness signaling upon determining a change in data rate that satisfies a predefined percent or absolute threshold. In some embodiments, the RAN awareness signaler 522 periodically transmits the RAN awareness information. For example, the signaler 522 transmits updated QoS metrics at regularly scheduled intervals, such as every 50 milliseconds, 100 milliseconds, or another suitable duration. In some embodiments, the RAN awareness signaler 522 may periodically transmit the RAN awareness information, and separately (e.g., independently) transmit RAN awareness information responsive to a change in QoS metrics.

In process 606, the RAN awareness signaler 522 may be configured to provide the signaling (e.g., including the RAN awareness information) via the communication device 514(3) over the Uu interface to the transmitting endpoint 502(1). In process 706, the RAN awareness signaler 522 may be configured to provide the signaling (e.g., including the RAN awareness information) over the N6 interface via the network 566 to the application server endpoint 502. In some embodiments, the RAN awareness signaler 522 may be configured to provide the signaling based on the detected media/information/data by the UPF 562 from the application server endpoint 502. For example, the UPF 562 may be configured to add, insert, or otherwise include a predefined flag in a GPRS Tunneling Protocol User-plane (GTP-U) extension header of the packet(s) transmitted at process 704. The UPF 562 may be configured to send the packets with the included flag via the N3 interface to the wireless communication node 504. The flag provided by the UPF 562 within the GTP-U extension header may be configured to explicitly request or instruct the wireless communication node 504 to provide RAN awareness information (e.g., QoS metrics) associated with the corresponding packet flow in the downlink (DL) direction. Upon receiving the flagged packets, the wireless communication node 504 may be configured to identify the request within the GTP-U extension header and correspondingly determine the QoS conditions/QoS metrics using the QoS detector 520, as described above. The RAN awareness signaler 522 may be configured to transmit or otherwise provide the determined RAN awareness information (including the QoS metrics) back upstream on the N3 interface via the user plane 556 toward the UPF 562. The UPF 562 may be configured to receive the signaling including the uplink-directed RAN awareness information (e.g., within a response uplink GTP-U packet) from the wireless communication node 504, and forward the RAN awareness information via the N6 interface and network 566 within IP-level signaling (e.g., UDP-option headers, application-level metadata, or header extensions) toward the application server endpoint 502.

The transmitting endpoint 502 may include a QoS determination engine 524. The QoS determination engine 524 may be designed or configured to parse or otherwise extract QoS metrics included in the signaling from the wireless communication node 504. As described above, these QoS metrics may include available or recommended data rates indicated for particular QoS flow(s) (or groups of flows/for the node), and/or QoS conditions (e.g., throughput rate, packet loss ratio, delay measurements, or congestion information) determined by the wireless communication node 504. The QoS determination engine 524 may be configured to determine a QoS for each of the flow(s) maintained or otherwise used by the endpoint 502 (e.g., in the communication channel or link with the wireless communication node 504) and/or generally for the communication channel or link. For example, the QoS determination engine 524 may be configured to map the QoS metrics of the RAN awareness information included in the signaling to the respective QoS flows used by the endpoint 502 (e.g., based on a QoS flow identifier included in the signaling and associated with the QoS metrics). As another example, the QoS determination engine 524 may be configured to determine the QoS generally for the communication channel or link, based on a combined/averaged/composite of the QoS metrics of the RAN awareness information.

At process 608 and 708, the transmitting endpoint 502 may include an adaptation engine 526 which is designed or configured to generate, determine, produce, establish, provide, or otherwise adapt traffic generated by the endpoint 502 according to the RAN awareness information. In some embodiments, the adaptation engine 526 adapts traffic by modifying one or more encoding or transmission parameters based upon the QoS metrics indicated in the received RAN awareness information. For instance, the adaptation engine 526 may selectively modify bitrates, adjust codec parameters for encoding, reallocate certain packets or packet flows between QoS flows, and/or selectively discard packets or data streams, as described below.

In some embodiments, the adaptation engine 526 adapts traffic by modifying a bitrate of subsequent packet(s). For instance, responsive to receiving QoS metrics indicating a reduction in available QoS flow throughput or increases in packet loss and/or latency, the adaptation engine 526 may be configured to reduce the subsequent packet encoding bitrate used by encoder 516(1). Similarly, responsive to receiving QoS metrics indicating improved radio conditions (such as increased throughput or reduced congestion), the adaptation engine 526 may be configured to increase subsequent packet encoding bitrate. The adaptation engine 526 may be configured to generate and/or encode subsequent packet(s) based on, according to, or using the updated/modified/adapted encoding bitrate.

In some embodiments, the adaptation engine 526 adapts traffic by modifying codec parameters used by encoder 516(1). For example, after receiving QoS metrics indicating higher congestion or reduced available throughput, the adaptation engine 526 may be configured to reduce spatial and/or temporal video resolution, increase quantization parameters (QP), modify audio sampling rate, and/or adjust other codec-specific parameters (such as a forward error correction rate). In some embodiments, the adaptation engine 526 adapts traffic by reallocating traffic between QoS flows. For instance, responsive to receiving QoS metrics that indicate increased delay, congestion, or packet loss for a particular QoS flow, the adaptation engine 526 may be configured to shift/move/reallocate selected packets or portions of traffic from the affected QoS flow to another QoS flow having different QoS metrics. In some embodiments, the adaptation engine 526 adapts traffic by selectively discarding packet(s). For example, upon receipt of QoS metrics indicating limited throughput availability, heavy congestion, or degraded latency conditions, the adaptation engine 526 may selectively discard or omit particular packets or packet-priority levels which correspond to non-essential or lower-priority information (such as background information or redundant frames).

In some embodiments, the adaptation engine 526 may be configured to adapt traffic relative to respective QoS metrics corresponding to each QoS flow used by the transmitting endpoint 502. In some embodiments, the adaptation engine 526 may be configured to apply individual adaptation solutions/configurations (such as modifying bitrates, adjusting codec parameters, reallocating packets, and/or selectively discarding data) to traffic associated specifically with each QoS flow. For example, the adaptation engine 526 may be configured to independently reduce encoding bitrate or codec resolution settings for packet(s) associated with a first QoS flow, responsive to QoS conditions indicating reduced throughput or increased packet loss specifically for that first QoS flow. Concurrently, the adaptation engine 526 may be configured to maintain (or increase) bitrates or encoding parameters for packet(s) associated with a second QoS flow having, e.g., lower latency, reduced congestion, or lower packet loss.

At process 610 and 710, the transmitting endpoint may be configured to communicate, transmit, send, or otherwise provide packet(s) to the receiving endpoint. The transmitting endpoint 502 may be configured to provide the packet(s) according to the QoS metrics from the RAN awareness information received from the wireless communication node 504. Process 610 may be the same as/similar to process 604, and process 710 may be the same as/similar to process 704. However, in process 610 and 710, the traffic/packets may be adapted/configured/generated based on the RAN awareness information indicated in the signaling.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a wireless communication endpoint from a wireless communication node, signaling indicating radio-access network (RAN) awareness information including one or more quality of service (QoS) metrics for the wireless communication node; and
transmitting, by the wireless communication endpoint, one or more packets to the wireless communication node according to the QoS metrics from the RAN awareness information received from the wireless communication node.

2. The method of claim 1, further comprising generating, by the wireless communication endpoint, the one or more packets using a bitrate determined according to the QoS metrics from the RAN awareness information received from the wireless communication node.

3. The method of claim 2, wherein the one or more QoS metrics are for one or more QoS flows used by the wireless communication endpoint, and wherein the method further comprises determining, by the wireless communication endpoint, the bitrate for generating the one or more packets based on the QoS metrics for each of the one or more QoS flows.

4. The method of claim 1, wherein the QoS metrics include a data rate for use by the wireless communication endpoint for transmitting the one or more packets on a QoS flow.

5. The method of claim 4, further comprising generating, by the wireless communication endpoint, the one or more packets according to a bitrate determined based on the data rate indicated in the RAN awareness information.

6. The method of claim 1, wherein the wireless communication endpoint comprises at least one of a user equipment or an application server.

7. The method of claim 1, wherein the QoS metrics include at least one of i) an indication of a portion of packets dropped during transmission by the wireless communication node, ii) a time delay for a packet to be transmitted by the wireless communication node, or iii) a level of traffic on a wireless network corresponding to the wireless communication node.

8. The method of claim 7, wherein the indication and the time delay corresponds to a QoS flow of a plurality of QoS flows.

9. The method of claim 1, wherein the signaling comprises at least one of a medium access control control element (MAC CE) signaling or a radio resource control (RRC) signaling.

10. The method of claim 1, wherein the one or more QoS metrics comprise a change from one or more first QoS metrics to one or more second QoS metrics.

11. A wireless communication endpoint, comprising:
one or more processors configured to:
receive, via a receiver from a wireless communication node, signaling indicating radio-access network (RAN) awareness information including one or more quality of service (QoS) metrics for the wireless communication node; and
transmit, via a transmitter to the wireless communication node, one or more packets according to the QoS metrics from the RAN awareness information received from the wireless communication node.

12. The wireless communication endpoint of claim 11, wherein the one or processors are further configured to generate the one or more packets using a bitrate determined according to the QoS metrics from the RAN awareness information received from the wireless communication node.

13. The wireless communication endpoint of claim 12, wherein the one or more QoS metrics are for one or more QoS flows used by the wireless communication endpoint, and wherein the one or more processors are configured to determine the bitrate for generating the one or more packets based on the QoS metrics for each of the one or more QoS flows.

14. The wireless communication endpoint of claim 11, wherein the QoS metrics include a data rate for use by the wireless communication endpoint for transmitting the one or more packets on a QoS flow.

15. The wireless communication endpoint of claim 14, wherein the one or more processors are further configured to generate the one or more packets according to a bitrate determined based on the data rate indicated in the RAN awareness information.

16. The wireless communication endpoint of claim 11, wherein the wireless communication endpoint comprises at least one of a user equipment or an application server.

17. The wireless communication endpoint of claim 11, wherein the QoS metrics include at least one of i) an indication of a portion of packets dropped during transmission by the wireless communication node, ii) a time delay for a packet to be transmitted by the wireless communication node, or iii) a level of traffic on a wireless network corresponding to the wireless communication node.

18. The wireless communication endpoint of claim 17, wherein the indication and the time delay corresponds to a QoS flow of a plurality of QoS flows.

19. The wireless communication endpoint of claim 11, wherein the signaling comprises at least one of a medium access control control element (MAC CE) signaling or a radio resource control (RRC) signaling.

20. A non-transitory computer readable medium storing instructions that, when executed by one or more processors, cause the one or more processors to:
receive, via a receiver from a wireless communication node, signaling indicating radio-access network (RAN) awareness information including one or more quality of service (QoS) metrics for the wireless communication node; and
transmit, via a transmitter, one or more packets to the wireless communication node according to the QoS metrics from the RAN awareness information received from the wireless communication node.
